(19) United States
(12) Patent Application Publication
(10) Pub. No.: US 2021/0241627 A1
(43) Pub. Date: Aug. 5, 2021

(54) OVERDUE PARKING WARNING

(71) Applicant: TOYOTA MOTOR NORTH AMERICA, INC., Plano, TX (US)

(72) Inventors: Joshua Babcock, Dallas, TX (US); Scott Meyer, Allen, TX (US)

(73) Assignee: TOYOTA MOTOR NORTH AMERICA, INC., Plano, TX (US)

(21) Appl. No.: 16/778,543

(22) Filed: Jan. 31, 2020

(51) Int. Cl. G08G 1/00; G08G 1/14; H04W 4/44

(52) U.S. Cl. CPC G08G 1/205; G08G 1/147; G08G 1/149; H04W 4/44; G08G 1/148

(57) ABSTRACT

A vehicle parking notification system, including an in-vehicle electronic device including a first wireless communication controller configured to respond to a request for a vehicle id, retrieve position information of the vehicle when the request for the vehicle id is made, the position information indicating that the vehicle is located in a parking facility, and record in memory a time that the request for vehicle id is made and the position information; and an external computer, remote from the vehicle, including processing circuitry configured to: receive, via a second wireless communication controller circuitry, an expiration time that parking at the parking facility expires determined based on the time associated with the request for vehicle id, and display, via a display device, at a predetermined time period before the expiration time a notification message indicating the at least one predetermined time period before the expiration time.

### BACKGROUND

### Technical Field

The present disclosure is directed to a communication system between a parking facility and a car owner to assist in clearing the parking facility by a certain time or preventing a car of the car owner from being towed.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Typically, parking facilities need to be free of vehicles after a certain time of day (e.g., 2:00 AM, 3:00 AM), referred to, for example as a closing time, cut-off time, or a time indicated in a towing notification message. In addition, parking facilities charge a fee for parking in the parking facility, where the fee may be in accordance with a maximum time period that the vehicle is expected to remain in the parking facility. Some parking facilities may monitor the particular parking spot that a vehicle is parked in. Still other parking facilities may provide a timestamped ticket upon entry, then accept payment based on the length of time parked, when the vehicle exits the parking facility. Some parking spaces have parking meters or parking kiosks that accept prepayment of specific time periods up to a maximum length of time, e.g., 2 hour parking limit. Some public parking spaces do not charge for parking, but have a maximum time limit, after which the vehicle may be subject to towing.

However, drivers of vehicles may forget or be otherwise unable to retrieve their vehicles by the cut-off time, a paid expiration time, or other maximum time limit. In another example, a driver may not know that a parking meter is about to expire or a maximum time limit is about to expire, may be preoccupied with other tasks, or may otherwise be unable to get to the driver's vehicle, which may lead to a possibility of the vehicle being towed.

Telematics systems are increasingly being installed in many models of vehicles. Telematics systems may include a satellite positioning unit to provide information on the position of the vehicle and a communication device for transmitting the position information.

The telematics system may store the position information and track movements of the vehicle. Some telematics systems may track location and movements of a fleet of several vehicles.

Despite the availability of telematics technology in vehicles, only limited information is available to a vehicle driver when the vehicle is parked in a parking facility or at a parking meter and the vehicle driver is at a location remote from the vehicle. Typically, at a time of entry, upon making a payment at a parking meter, or at a parking kiosk, a driver may receive a printed ticket indicating the expiration time of a prepaid parking spot or parking meter. In other cases, a vehicle driver may be informed upon entrance to a parking facility of parking rates and times. A sign or signs may be posted that show a closing time or other time when a vehicle must be moved out of the parking facility, and in some cases the vehicle may be subject to towing if it remains beyond the posted time. In some cases, vehicles remaining in the parking facility after closing may be enclosed (e.g., the parking facility has a gate or door to prevent entrance or exit from the facility) such that access to the vehicle may not be made until the parking facility reopens. In other cases, vehicles remaining in the parking facility after closing may be towed out of the parking facility to clear the lot. In the case of vehicles parked at parking meters, a vehicle remaining at the parking meter after expiration of the prepaid time period may be ticketed by a parking service attendant, or may even be towed after a certain period of time. Still further, some parking facilities may not charge for parking, but may have policies, such as that vehicle are not permitted to be parked after a certain time, or may not be allowed to remain overnight. With such a large variety of parking situations that a driver may encounter, there is a need to provide the driver with notifications that provide timely information of the particular parking situation, preferably before an event such as an expiration time, or closing time, and allow the driver take appropriate action even while being at a location away from the vehicle.

It is one object of the present disclosure to describe a system and method that provides notifications to a vehicle owner or vehicle driver to avoid a condition in which the vehicle is towed, and avoid overdue parking charges and/or tickets, or to notify the vehicle owner or vehicle driver of an event such as possible towing or that the parked vehicle will be inaccessible. An aspect is a chip that may be installed in the vehicle and configured to communicate with a parking facility which may monitor the location and entry and exit times of the vehicle without user intervention. An object is for the chip to enable the parking facility to monitor when the vehicle enters the parking facility, the space in which the vehicle has parked, and a time that the vehicle leaves the parking facility. An aspect is a chip that may be installed in the vehicle and configured to communicate internally with a telematics system to monitor position of the vehicle, and time of entry into a parking facility. An aspect is a smartphone app or other communication device for remote notification of parking related events and payment for parking fees.

### SUMMARY

In an exemplary embodiment, a vehicle parking notification system includes an in-vehicle electronic device including a first wireless communication controller circuitry, a memory storing a vehicle id, at least one antenna, the first wireless communication controller configured to: respond to a request for the vehicle id, via the at least one antenna, retrieve position information of the vehicle when the request for the vehicle id is made, the position information indicating that the vehicle is located in a parking facility, and record in the memory a time that the request for vehicle id is made and the position information; and an external computer, remote from the vehicle, including processing circuitry, a second wireless communication controller circuitry, and a display device, the processing circuitry configured to: receive, via the second wireless communication controller circuitry, an expiration time that parking at the parking facility expires determined based on the time associated with the request for vehicle id, and display, via the display device, at a predetermined time period before the expiration time a notification message indicating the at least one predetermined time period before the expiration time.

In an exemplary embodiment, a non-transitory computer-readable storage medium storing program instructions which when executed by processing circuitry perform a method including wirelessly responding, by an in-vehicle wireless communication controller circuitry, to a request for the vehicle id; retrieving, by the in-vehicle wireless communication controller circuitry, position information of the vehicle when the request for the vehicle id is made, the position information indicating that the vehicle is located in a parking facility; recording in a memory, connected to the in-vehicle wireless communication controller circuitry, a time that the request for vehicle id is made and the position information; receiving, via a second wireless communication controller circuitry of an external remote computer, an expiration time that parking at the parking facility expires determined based on the time associated with the request for vehicle id; and displaying, via a display device of the external remote computer, at a predetermined time period before the expiration time a notification message indicating the at least one predetermined time period before the expiration time.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a system diagram for a mobile object having an electronic device in accordance with an exemplary aspect of the disclosure;

FIG. 2 is a system diagram for a vehicle monitoring service in accordance with an exemplary aspect of the disclosure;

FIG. 3 is a block diagram of a communications chip for the vehicle monitoring service in accordance with an exemplary aspect of the disclosure;

FIG. 4 is a flowchart for a method of notifying a driver that time is approaching a cut-off time in accordance with an exemplary aspect of the disclosure;

FIG. 5 is a flowchart for a method of monitoring vehicle status in a parking facility in accordance with an exemplary aspect of the disclosure;

FIG. 6 is an interface screen for a mobile device in accordance with an exemplary aspect of the disclosure;

FIG. 7 is an interface screen for a mobile device in accordance with an exemplary aspect of the disclosure;

FIG. 8 is an interface screen for a mobile device in accordance with an exemplary aspect of the disclosure;

FIG. 9 is an interface screen for a mobile device in accordance with an exemplary aspect of the disclosure;

FIG. 10 is an interface screen for a mobile device in accordance with an exemplary aspect of the disclosure;

FIG. 11 is an interface screen for a computer display device in accordance with an exemplary aspect of the disclosure;

FIG. 12 is an interface screen for a computer display device in accordance with an exemplary aspect of the disclosure;

FIG. 13 is an interface screen for picture taking in a mobile device in accordance with an exemplary aspect of the disclosure;

FIG. 14 is a system diagram for registration of a vehicle in accordance with an exemplary aspect of the disclosure;

FIG. 15 is an interface screen for a computer display device in accordance with an exemplary aspect of the disclosure;

FIG. 16 is an interface screen for a mobile device in accordance with an exemplary aspect of the disclosure;

FIG. 17 is a block diagram of a mobile device in accordance with an exemplary aspect of the disclosure; and

FIG. 18 is a block diagram of a computer system in accordance with an exemplary aspect of the disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Aspects of this disclosure are directed to a communication chip embedded in a vehicle for facilitating communication with a vehicle driver with regard to parking status of the vehicle either in a parking facility or a parking meter, as well as any parking location that has time limitations. The embedded communication chip facilitates communication with a vehicle monitoring service. The embedded communication chip communicates with a vehicle monitoring service which can inform a driver of parking status of the vehicle and provide the driver with a capability to pay for additional parking remotely. In some embodiments, the embedded communication chip facilitates communication between a vehicle and a parking facility. In some embodiments, the embedded communication chip may communicate with the parking facility to assist in clearing the parking facility or prevent a vehicle from being towed. The embedded communication chip facilitates a service for a parking facility that needs to clear its lot by a certain time. The embedded communication ship facilitates a service in which a parking meter(s) may inform a driver of parking status and may receive payments through a mobile device parking application. The embedded communication chip facilitates a service in which a commercial company with a fleet of vehicles may monitor parking status of its vehicles that are parked at parking facilities and/or parking meters.

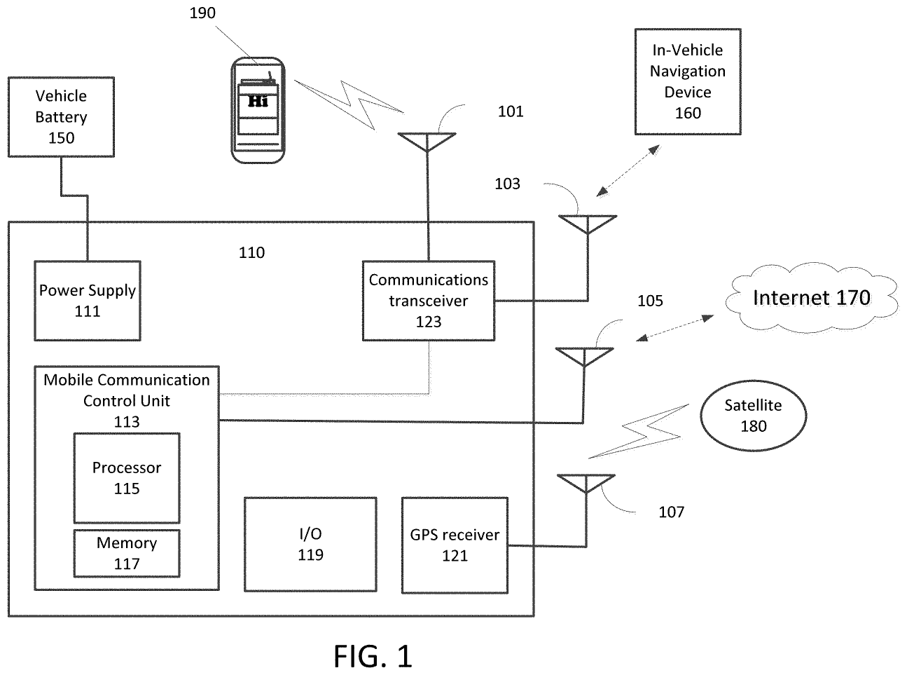

FIG. 1 is a system diagram for a road vehicle having an electronic device in accordance with an exemplary aspect of the disclosure. An electronic device or communication chip may be installed in a vehicle during manufacturing as an option. In some embodiments, the electronic device 110 may be configured with several communication circuits. A mobile communication control circuit 113 may be configured for cellular communications of data over the Internet 170 via antenna 105. Communications over the internet may include transmission of data in the form of IP packets using SMS (Short Message Service) or GPRS (General Packet Radio Service). The mobile communication control unit 113 may include a processor 115 and memory device 117 so that processing may be performed on data received from the Internet 170, GPS (Global Positioning System) data, or data to or from a communications transceiver 123. The communications transceiver 123 may be configured for short range communication, via antenna 103, with in-vehicle devices such as an in-vehicle navigation device 160. The short range communication may use Bluetooth or Bluetooth Low Energy (BLE). The communications transceiver 123 may be configured for medium range communications, via antenna 101, such as communication with a mobile device 190 or other external service using the Wi-Fi protocol. The electronic device 110 may include its own global positioning system (GPS) receiving unit 121 and antenna 107 for communications with a GPS satellite 180 in order to receive the GPS signal. The processor may use the GPS signal to calculate GPS coordinates. The electronic device 110 may include a power supply 111 that receives power from the vehicle battery 150. The electronic device 110 may include one or more I/O ports 119 for connection with other components in the vehicle, such as an engine electronic control unit (ECU), or temporary connection with another electronic device for purposes of programming, updating, or obtaining internal data from the memory 117.

The memory 117 of the electronic device 110 may store vehicle information including a vehicle ID, data received by any of the communication circuits, vehicle status information including a timestamp associated with received data. In some embodiments, the memory 117 may include one or more cell phone numbers that may be used to send SMS messages.

In some embodiments, the mobile communication control unit 113 may be configured to send messages to a vehicle driver with regard to status of the vehicle, such as a time of entry either in a parking facility or at a parking meter, or an expiration time calculated based on the time of entry or received from an external source.

In some embodiments, the communications transceiver 123 may be configured to communicate with a communication device of a parking facility for transmitting vehicle ID information to the parking facility and for automatically receiving and recording time of entry or time of leaving the parking facility in the memory 117.

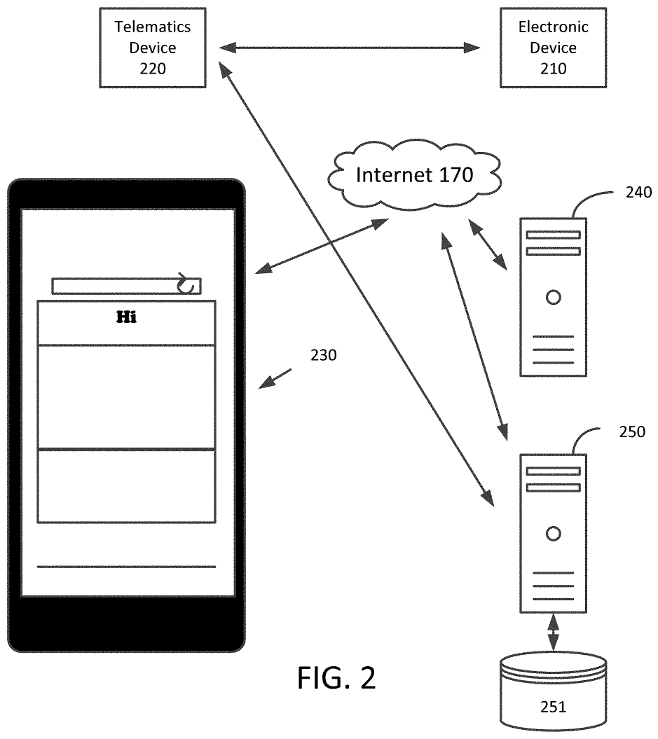

FIG. 2 is a system diagram for a vehicle monitoring service in accordance with an exemplary aspect of the disclosure. An electronic device 210 may provide an enhancement to a vehicle-based system, such as a telematics system 220 and an infotainment system. A telematics system 220 may take that data and send it via a cellular network to computers 250. From there, the data can be processed, converted into usable information and accessed from any computer device connected to the Internet 170. The computers 250 may perform a vehicle monitoring service that includes an associated database 251 for maintaining vehicle status information. A parking facility, parking meter, or parking kiosk may have a server 240 for monitoring status of vehicles parking at the parking facility, parking meter, or parking kiosk. Although the server 240 and server 250 are shown as separate equipment, it should be understood that the services provided by each of the servers may be performed on a single computer equipment or may be performed in a cloud service platform or other computer network. A mobile device 230 may communicate with a vehicle infotainment system 220 when within communications range or directly connected using, for example, USB, or other communication port. The mobile device 230 may establish a communications link with the server 250 via the Internet 170 in order to set up an account for a vehicle and receive status information related to the vehicle when it is parked at a parking facility, parking meter, or other paid parking space.

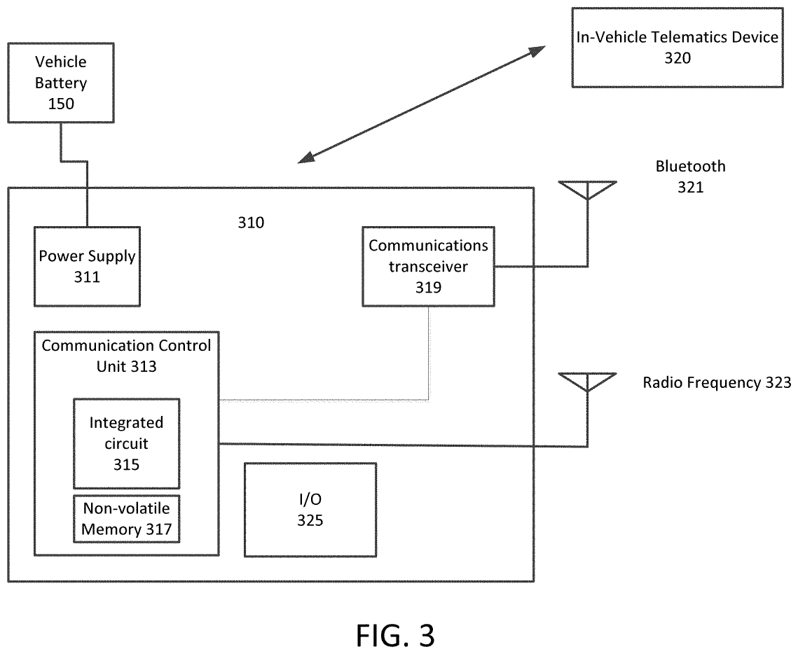

FIG. 3 is a block diagram of a communications chip for the vehicle in accordance with an exemplary aspect of the disclosure. In some embodiments, the communications chip 310 may contain a minimal set of communication-related circuitry, processing circuitry, and memory, and rely on the in-vehicle telematics system 320 or infotainment system for other higher-level processing and determining vehicle location. In some embodiments, the vehicle monitoring service may utilize functions of a mobile device 230 for global positioning system satellite position detection, cellular communication when the mobile device is within the vehicle cabin or directly connected to the in-vehicle infotainment system.

The minimized communications chip 310 may include a communications transceiver 319 for short range communication, for example, Bluetooth via Bluetooth antenna 321, or Bluetooth Low Energy (BLE). The communications chip 310 may include a communication control unit 313 that is configured for radio frequency communication via a radio frequency antenna 323. In some embodiments, the communication chip 310 is configured to communicate with a communications device associated with a parking facility, for example, using radio frequency communication.

The communication control unit 313 may include an integrated circuit 315 and associated memory 317, e.g. non-volatile memory or a combination of non-volatile memory and volatile memory, for control of communications and other processing for data received or transmitted by the short range communication antenna 321 or radio frequency antenna 323.

The communications chip 310 may include its own power supply 311 that obtains power from the vehicle battery 150. In some embodiments, the power supply 311 may be an external device, separate from the communications chip 310. In some embodiments, the communications chip 310 may include an I/O interface 325 for data or signal transfer with an external device.

In some embodiments, a vehicle monitoring service may provide vehicle drivers or owners with notifications regarding parking status, such as approaching a parking facility cut-off time and an expired amount of time for parking.

If the vehicle is still within the parking facility near the cut-off time, a notification message may be sent to the vehicle driver or owner by way of a mobile device application, e-mail, and/or SMS text message. In another example, a notification may be automatically sent to a towing facility to come tow the vehicle when the vehicle is present in the parking facility after the parking facility cut-off time. A notification message informing of the towing with towing company details may be sent to the vehicle driver or owner by way of the mobile device application, e-mail, and/or SMS text message.

In another embodiment, notification messages may be sent to a vehicle driver or owner when the time in the parking facility or at a parking meter is approaching the amount of time purchased (e.g., the vehicle driver or owner purchased an hour of parking time and 50 minutes have gone by). Using a mobile device application, the vehicle driver or owner may be presented with the option of paying for additional parking time.

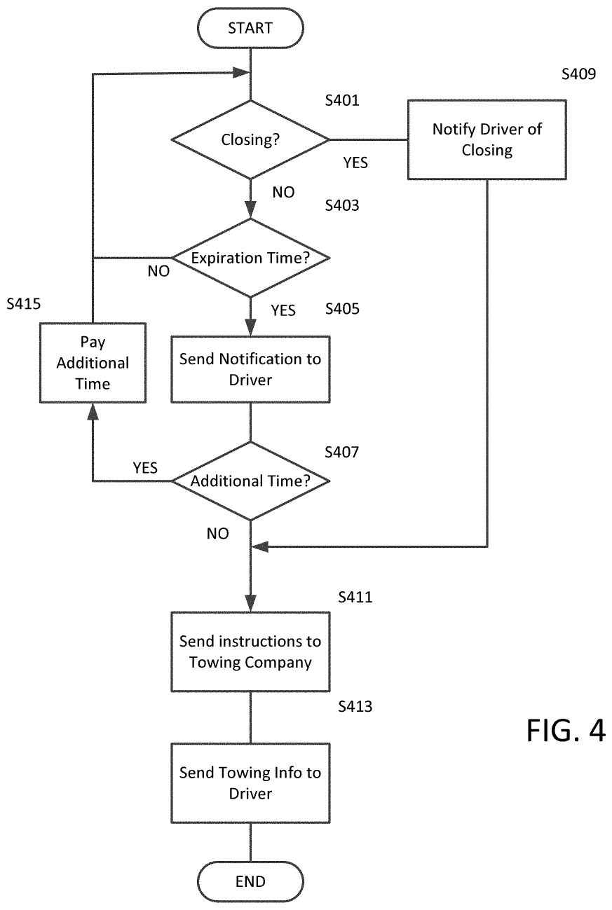

An exemplary operation based on a vehicle monitoring service is shown in FIG. 4. FIG. 4 is a flowchart for a method of notifying a driver that time is approaching a cut-off time in accordance with an exemplary aspect of the disclosure. Although the steps in the flowchart are presented in an order, it should be understood that the order of steps may be different than as shown. Also, some steps may be omitted. For example, a feature of providing payment for additional parking time may be optional. Also, a feature of checking whether the current time is near closing time, e.g., 5 or 10 minutes before closing, may be replaced with a step of broadcasting a reminder to all vehicles remaining in a parking facility at a certain predetermined time, e.g., 1 hour before closing time.

In some embodiments, the steps in FIG. 4 are performed by a server 250 that executes a vehicle monitoring service. In some embodiments, the steps in FIG. 4 may be performed in a server 240 associated with a parking facility, or an independent third party that manages several parking facilities and/or parking services. In the case of a server 250 executing a vehicle monitoring service, the information for a vehicle, including position of the vehicle and time of entry of the vehicle into a parking facility may be determined using the global positioning system (GPS) receiver 121 of the electronic device 110, or the in-vehicle telematics system 320. The information of the position and time of entry into a parking facility may be stored in relation with vehicle identification information in database system 251. Vehicle identification information may be previously stored when a user initially registers with the vehicle monitoring service. Each time position information and time of entry information is sent from a vehicle, an id that identifies the vehicle is transmitted via the electronic device 110 or using an in-vehicle telematics device 320 using data from an electronic device 310.

In S401, a determination may be made as to whether a closing time, maximum checkout time, or other time that a parking facility has set, has been reached, or is within a predetermined amount of time before, such as 15 minutes, 10 minutes, 5 minutes before a maximum checkout time. The determination in S401 may be performed to cover conditions where the current time is before a paid expiration time, but the maximum checkout time of the parking facility has been reached or is about to be reached. In S403, a determination is made as to whether the current time is a predetermined amount of time before the expiration time, or is the expiration time, of a parking time period that was paid for. In some embodiments, the predetermined amount of time before the expiration time may be previous set by a registered user, or may be one or more time amounts, such as increments of every five minutes, or 15 minutes, 10 minutes, 5 minutes before an expiration time.

In S409, a notification message may be sent to a vehicle driver or vehicle owner by way of a mobile device application, e-mail message and/or SMS message. The message may be an early notification of the maximum cutoff time of a parking facility and its towing policy. The message may be a notification that the parking facility is approaching its maximum cutoff time, or may be a warning that the parking facility is closed and may either tow the vehicle to clear the facility or be subject the vehicle to additional charges for overnight parking, or other course of action determined by the parking facility. In S405, a notification message may be sent to a vehicle driver or vehicle owner to indicate that the paid parking time is about to expire, for example 15 minutes before the expiration time, or that the expiration time has been reached. In some embodiments, the notification message may include an input to pay for additional parking time. In these embodiments, in S407, a determination is made as to whether additional time has been requested. In S415, if additional time is requested, payment for the additional time may be made by way of a mobile device application, Web interface, or by other available payment approach, such as by phone call.

In S411, when a maximum checkout time has been reached, or a parking expiration time has been reached and no additional parking time period has been obtained, the vehicle monitoring service may send instructions to a towing company regarding towing of the vehicle. In some embodiments, the vehicle monitoring service may contact one or more towing companies to have any vehicles remaining in a parking facility towed to clear the parking facility.

In S413, the vehicle monitoring service may send a notification message to a vehicle driver or vehicle owner including information of the towing company and a location of where the vehicle may be picked up.

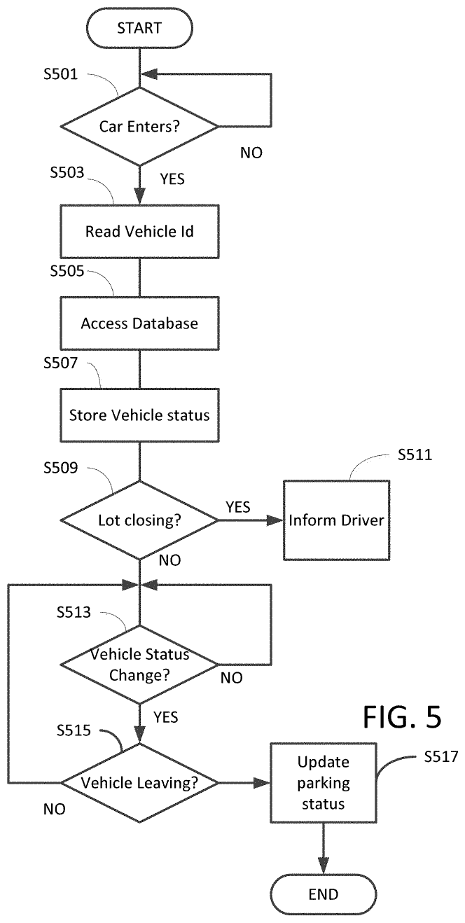

In some embodiments, a parking facility may include a server 240 configured to monitor vehicles as they enter and leave the parking facility. FIG. 5 is a flowchart for a method of monitoring vehicle status in a parking facility in accordance with an exemplary aspect of the disclosure. The parking facility may include a communication device configured to detect vehicle information in the electronic device 110, 310. The detected information may be an id associated with the vehicle. The communication device of the parking facility may be configured for short range communications, such as using Bluetooth or BLE, or other wireless data transmission. Once a vehicle id is detected, information of the vehicle, stored in database 251, may be obtained from the vehicle monitoring service via secure communication over the Internet.

In S501, a determination is made as to whether a vehicle has entered the parking facility, in which case (YES in S501), in S503, the vehicle id is read from the electronic device 110, 310 of the vehicle by a communication device of the parking facility. In S505, a database 251 of the vehicle monitoring system may be accessed to obtain vehicle information, such as vehicle make, model, color, license plate number, so that the vehicle may be identified within the parking facility. The vehicle monitoring service may monitor the location of the vehicle, and the location information may be used by the parking facility server 240 as status information of the vehicle in the parking facility. In S507, the server 240 of the parking facility may store the vehicle status, such as a specific parking space that the vehicle has parked in. The server 240 may be configured to take an action when parking facility is at or near a closing time. In some embodiments, the server 240 may perform an action at predetermined periods of time before the closing time, such as increments of 15 minutes, beginning at one hour before closing time. The action may include performing a check on vehicles that are parked within the parking facility. If the parking facility has a policy that all vehicles must be cleared from the parking facility by the closing time, in S511, a notification message may be sent to all vehicle drivers or owners using the vehicle monitoring service server 250 informing of closing time and informing of the towing policy. The server 240 of the parking facility may continue to monitor the location of a vehicle. For example, a vehicle may change its location to another parking space. In S513, a check is made to determine if the status of the vehicle has changed. In the case that a vehicle is leaving a parking facility, in S515, a check is made as to whether the vehicle has exited the parking facility, in which case, in S517, the status of the vehicle in the database 251 of the vehicle monitoring service is updated to show that the vehicle is no longer parked in the parking facility.

Notification of vehicle status may be by way of a smartphone app, e-mail message, and/or text message, depending on a preference of the vehicle driver or vehicle owner. The type of notification may be set up by a user through the smartphone app or through a Web site for a vehicle monitoring service.

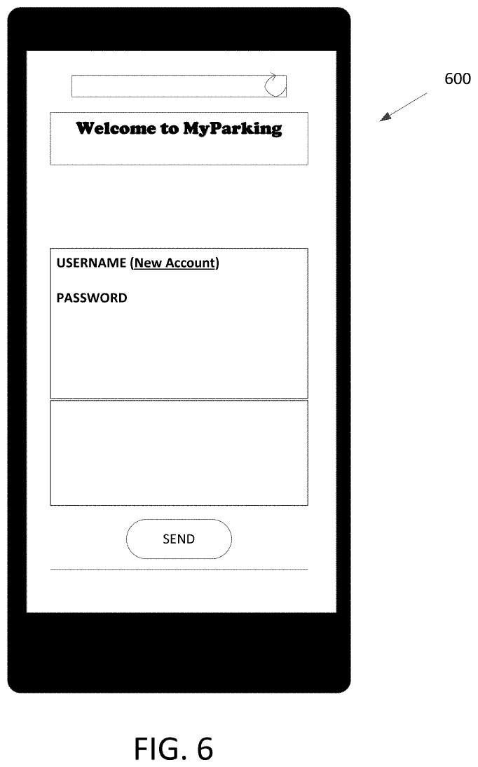

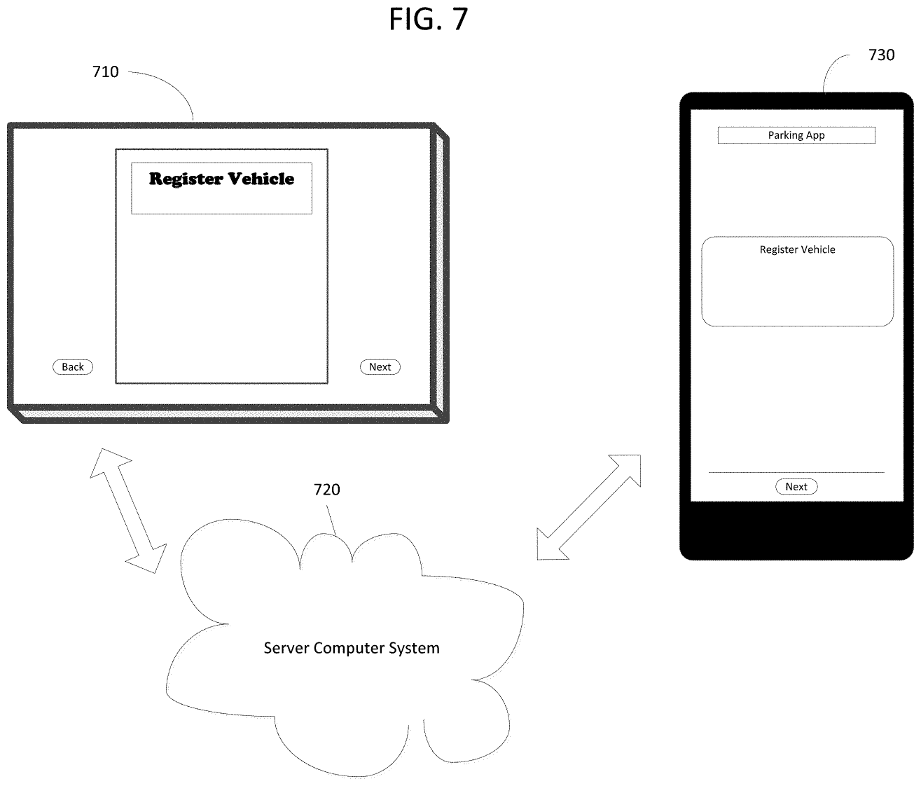

In order to establish an account in the database 251, a user may be provided with an interface on the smartphone app or Web site that enables a user to register a new account. FIG. 6 is an interface screen for a mobile device in accordance with an exemplary aspect of the disclosure. The interface 600 may present an input form in which a username and password may be entered. The interface may provide an option of setting up a new account, resetting a username and/or password, and other information about the application. As illustrated in FIG. 7, similar interface may be presented in a Web site 710 and either device 710 or 730 may communicate with a vehicle monitoring service vi a server computer system 720. It should be appreciated that the smartphone app may also be an app for a vehicle infotainment system.

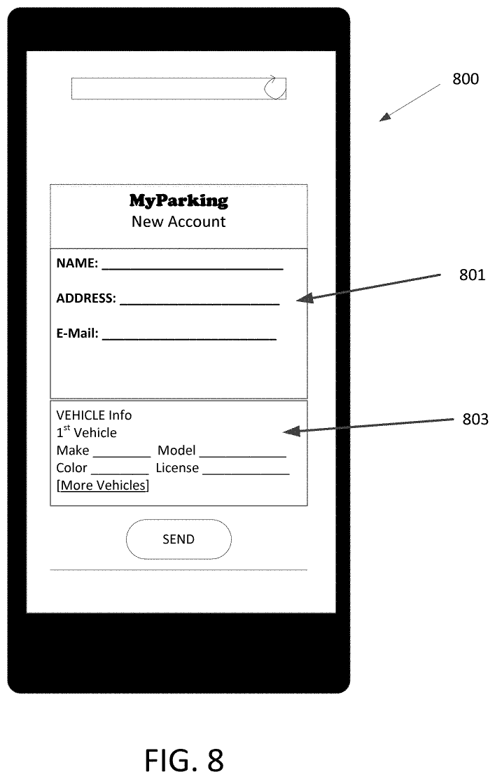

FIG. 8 is an interface screen for a mobile device in accordance with an exemplary aspect of the disclosure. In the case that the user is to set up a new account, a form 800 may be presented for input of user information 801 and input of vehicle information 803. In some embodiments, a new account may only be set up for a vehicle owner, with an option for the vehicle owner to include other drivers for the vehicle. In some embodiments, a new account may be set up for each vehicle driver such that the same vehicle information may be associated with multiple drivers. Also, a user may be presented with a form that enables input of vehicle information for multiple vehicles (Move Vehicles). A user may be presented with an option to input an e-mail address at the time of registration. A user may also choose to include an e-mail address and SMS text information at a later time. However, it is preferable that at least one communication method be selected at the time of registration. In some embodiments, the smartphone app may request permission to include the mobile phone number as information to be automatically sent when registration is performed.

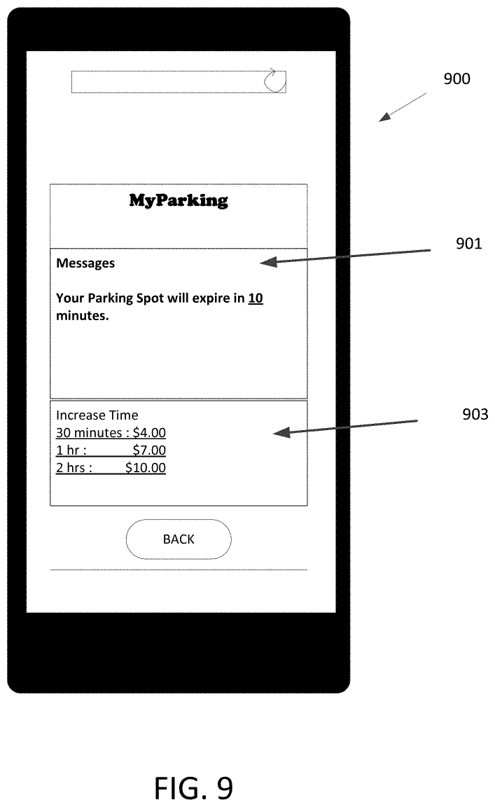

FIG. 9 is an interface screen for a mobile device in accordance with an exemplary aspect of the disclosure. The parking monitoring service may track the status of a vehicle in a database 251. The status of a vehicle may be presented by the interface 900 in a message 901 that includes time and place of entry into a parking facility, the parking spot where a vehicle is parked, the expiration time associated with the parking spot, and/or a closing time of a parking facility. A parking facility, via server 240, may make available to the parking monitoring service information such as a closing notification, a towing policy, towing service information, and parking attendant hours. The parking facility may make available parking rates and times. The vehicle monitoring service may use information in the database 251 and information made available by the parking facility to send notification messages to a registered user. FIG. 9 illustrates an exemplary notification message 901 informing a user of a parking expiration time. As an option, the notification message may provide an option 903 to pay for additional time without the user having to go back to the parking facility and pay for the parking space.

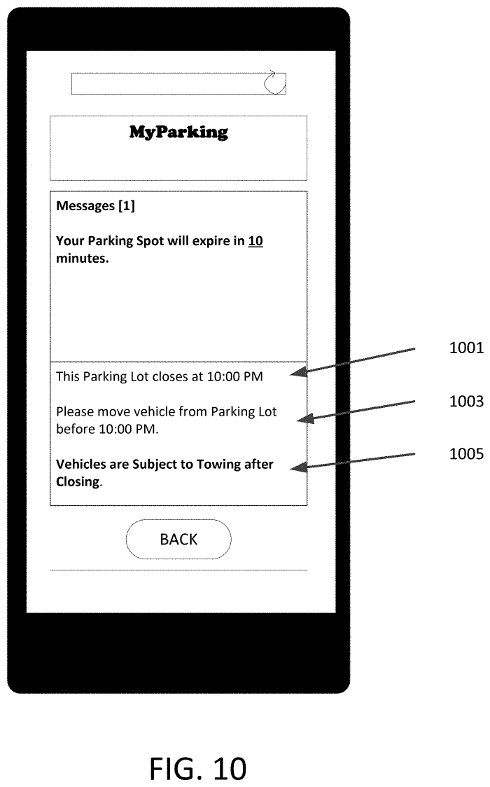

In some embodiments, the current time may be approaching a closing time for the parking facility, in which case an option to pay for additional time may not be available. Instead, as illustrated in FIG. 10, the vehicle monitoring service may send out a message 1001 that includes information about the closing time of the parking facility and instructions 1003 related to a parking facility policy, and may include information related to a towing policy 1005.

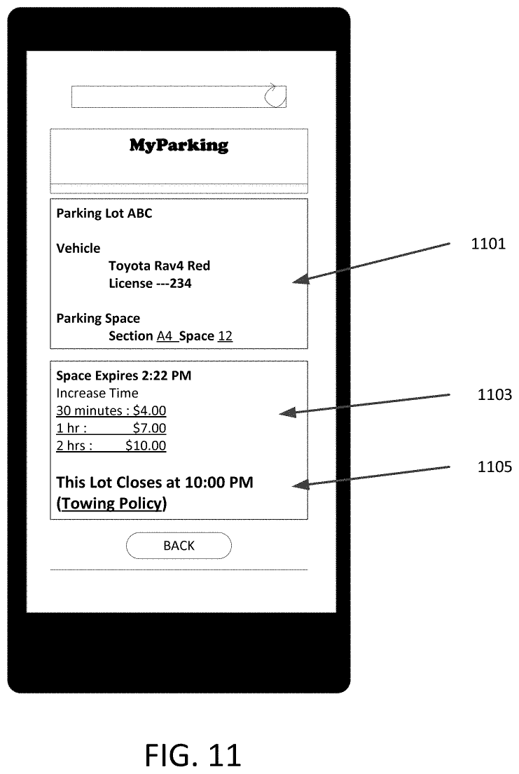

FIG. 11 is an interface screen for a mobile device in accordance with an exemplary aspect of the disclosure. In some embodiments, the vehicle monitoring service may send out information 1101 regarding a particular parking space in a certain parking facility as verification of the vehicle status. The interface may be a form that allows entry of information such as the particular parking space. The interface may include an option 1103 to pay for the parking space from the app and to increase the time for parking in the particular spot. The interface may include information about the parking facility 1105, such as when the parking facility closes and a towing policy. Information about parking fees, closing time and towing policy may be communicated from the parking facility, via server 240, to the parking monitoring service.

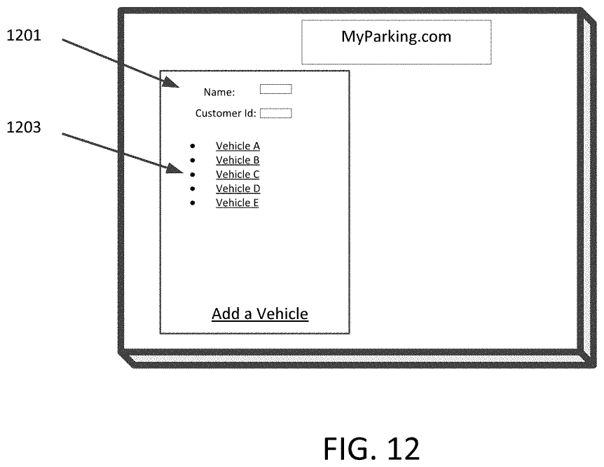

An aspect of the present disclosure is a parking monitoring service for a fleet of vehicles. A user may register several vehicles so that when a vehicle enters and parks in a parking facility, the vehicle can be monitored by the user of the service. FIG. 12 is an interface screen for a computer display device in accordance with an exemplary aspect of the disclosure. The computer display device may display an interface form for registering and managing several vehicles, and as a minimum may include an input for a customer name and identification 1201, as well as a list of registered vehicles 1203 having links to associated vehicle information. The form may enable registering or deleting vehicles from the list of registered vehicles.

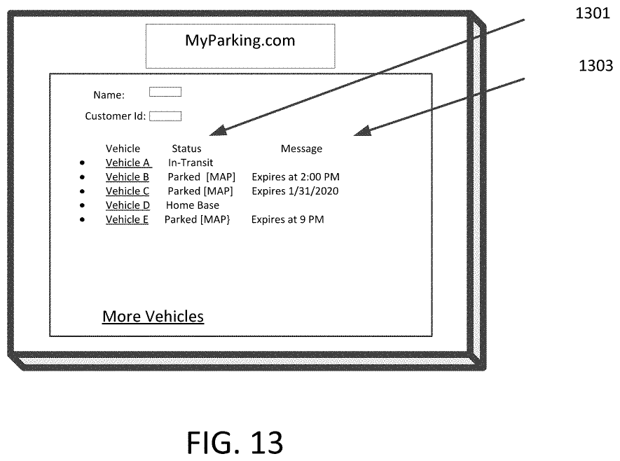

FIG. 13 is an interface screen for a computer display device in accordance with an exemplary aspect of the disclosure. The interface form for managing a fleet of vehicles may include a display that provides information for the status 1301 of each vehicle as well as any messages 1303 that are associated with the specific vehicle. The status 1301 may include an indication that a vehicle is parked in a parking facility that requires payment and the message may include an amount of time remaining until an expiration time.

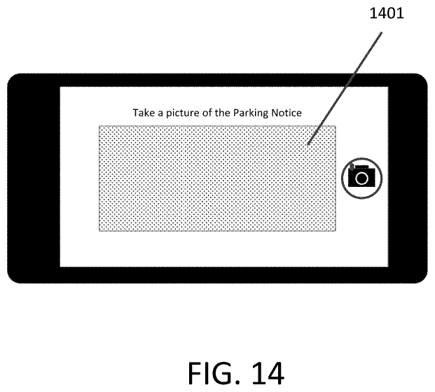

In some embodiments, the vehicle monitoring service may provide a text recognition function. As illustrated in FIG. 14, a smartphone app may include an image capture function 1401 in which an image of a parking facility notice may be captured and submitted to the parking monitoring service. The parking monitoring service may perform text recognition and store selected recognized text in the database 251. In some embodiments, the captured image may be for a notice posting parking rates for a parking facility, a closing time of the parking facility, and/or a towing policy. The vehicle monitoring service, via server 250, may extract the parking rate information from the recognized notice, so that the parking rate information may be used to determine a cost to increase parking time for a notification message provided to a vehicle driver. In some embodiments, a captured image of the notice, itself, may be attached to a notification message sent out to the user upon occurrence of an event, such as an approaching closing time or expiration time.

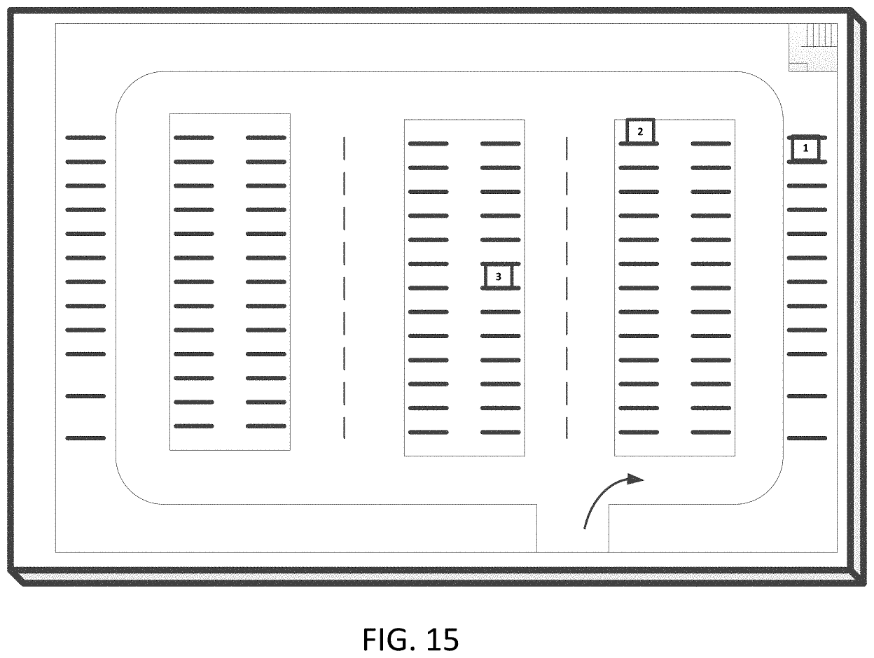

FIG. 15 is an interface screen for a computer display device in accordance with an exemplary aspect of the disclosure. In some embodiments, a smartphone app, Web site, or parking facility computer display may provide a display of the parking spaces in a parking facility. The display of the parking spaces may show status of the parking spaces. For example, the display for a smartphone app or Web site may show vacant parking spaces (marked 1, 2, 3) for the driver to choose from.

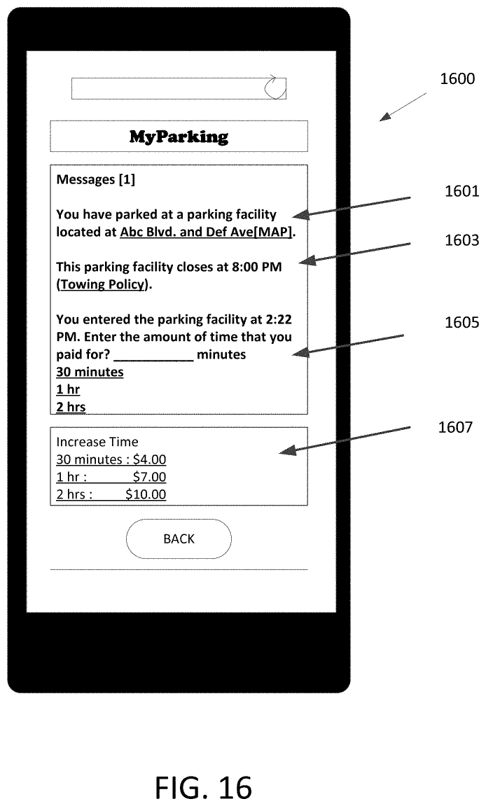

FIG. 16 is an interface screen for a mobile device in accordance with an exemplary aspect of the disclosure. A parking facility or other parking location may not have a separate server that tracks vehicles. In some embodiments, the parking monitoring service may include an interface 1600 for a smartphone app that shows information for status of a vehicle based on location information obtained from a GPS 121, 320 in the vehicle and information about a parking facility that has been previously stored in a database 251. The GPS may detect the location of the vehicle and determine a parking facility that the vehicle is located in. Information retrieved from the database 251 for the parking facility may include a closing time and towing policy. The GPS 121, 320 may record that the vehicle entered the parking facility at a certain time. As illustrated in FIG. 16, the interface 1600 may provide a form that verifies information about the parking facility that the vehicle has parked 1601, and may display the information about the parking facility 1603, such as its closing time and towing policy. The form may include an input 1605 of the amount of time that has been paid for, or a maximum time limit for parking at the parking facility. In some embodiments, the parking facility may offer a capability of making a payment to a third party, making a payment over the Internet, or making a payment by phone. In such case, the interface 1600 may include an option 1607 to increase an amount of time for parking in the space associated with the parking facility.

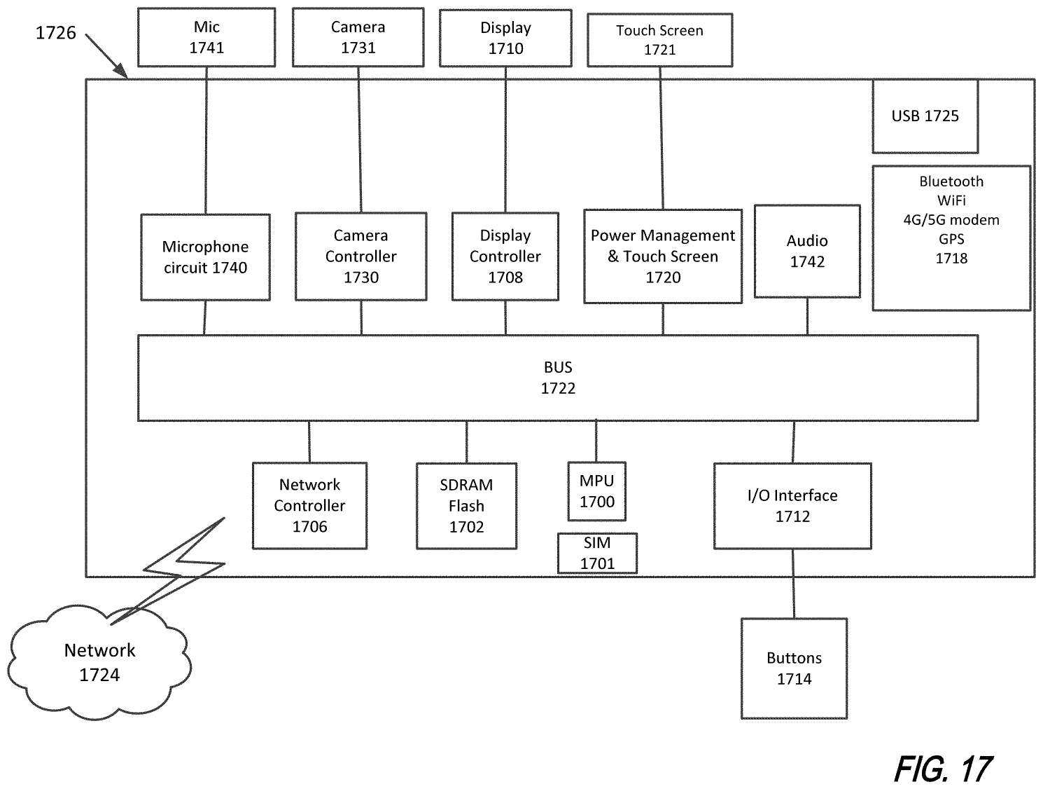

The mobile device, such as a smartphone, may be any wireless communication device having a display and a processing circuitry configured to execute a mobile device application (commonly referred to as an app). FIG. 17 is a block diagram of a mobile device in accordance with an exemplary aspect of the disclosure.

In one implementation, the functions and processes of the mobile device 130 may be implemented by one or more respective processing circuits 1726. A processing circuit includes a programmed processor as a processor includes circuitry. A processing circuit may also include devices such as an application specific integrated circuit (ASIC) and conventional circuit components arranged to perform the recited functions. Note that circuitry refers to a circuit or system of circuits. Herein, the circuitry may be in one computer system or may be distributed throughout a network of computer systems. Hence, the circuitry of the server computer system 120 for example may be in only one server or distributed among different servers/computers.

Next, a hardware description of the processing circuit 1726 according to exemplary embodiments is described with reference to FIG. 17. In FIG. 17, the processing circuit 1726 includes a Mobile Processing Unit (MPU) 1700 which performs the processes described herein. The process data and instructions may be stored in memory 1702. These processes and instructions may also be stored on a portable storage medium or may be stored remotely. The processing circuit 1726 may have a replaceable Subscriber Identity Module (SIM) 1701 that contains information that is unique to the network service of the mobile device 130.

Further, the claimed advancements are not limited by the form of the computer-readable media on which the instructions of the inventive process are stored. For example, the instructions may be stored in FLASH memory, Secure Digital Random Access Memory (SDRAM), Random Access Memory (RAM), Read Only Memory (ROM), Programmable Read-Only Memory (PROM), Erasable Programmable Read-Only Memory (EPROM), Electrically Erasable Programmable Read Only Memory (EEPROM), solid-state hard disk or any other information processing device with which the processing circuit 1726 communicates, such as a server or computer.

Further, the claimed advancements may be provided as a utility application, background daemon, or component of an operating system, or combination thereof, executing in conjunction with MPU 1700 and a mobile operating system such as Android, Microsoft® Windows® 10 Mobile, Apple iOS® and other systems known to those skilled in the art. In order to achieve the processing circuit 1726, the hardware elements may be realized by various circuitry elements, known to those skilled in the art. For example, MPU 1700 may be a Qualcomm mobile processor, a Nvidia mobile processor, a Atom® processor from Intel Corporation of America, a Samsung mobile processor, or a Apple A7 mobile processor, or may be other processor types that would be recognized by one of ordinary skill in the art. Alternatively, the MPU 1700 may be implemented on an Field-Programmable Gate Array (FPGA), Application Specific Integrated Circuit (ASIC), Programmable Logic Device (PLD) or using discrete logic circuits, as one of ordinary skill in the art would recognize. Further, MPU 1700 may be implemented as multiple processors cooperatively working in parallel to perform the instructions of the inventive processes described above. The processing circuit 1726 in FIG. 17 also includes a network controller 1706, such as an Intel Ethernet PRO network interface card from Intel Corporation of America, for interfacing with network 1724. As can be appreciated, the network 1724 can be a public network, such as the Internet, or a private network such as LAN or WAN network, or any combination thereof and can also include PSTN or ISDN sub-networks. The network 1724 can also be wired, such as an Ethernet network. The processing circuit may include various types of communications processors for wireless communications including 3G, 4G and 5G wireless modems, WiFi®, Bluetooth®, GPS, or any other wireless form of communication that is known.

The processing circuit 1726 includes a Universal Serial Bus (USB) controller 1725 which may be managed by the MPU 1700.

The processing circuit 1726 further includes a display controller 1708, such as a NVIDIA® GeForce® GTX or Quadro® graphics adaptor from NVIDIA Corporation of America for interfacing with display 1710. An I/O interface 1712 interfaces with buttons 1714, such as for volume control. In addition to the I/O interface 1712 and the display 1710, the processing circuit 1726 may further include a microphone 1741 and one or more cameras 1731. The microphone 1741 may have associated circuitry 1740 for processing the sound into digital signals. Similarly, the camera 1731 may include a camera controller 1730 for controlling image capture operation of the camera 1731. In an exemplary aspect, the camera 1631 may include a Charge Coupled Device (CCD). The processing circuit 1626 may include an audio circuit 1642 for generating sound output signals, and may include an optional sound output port.

The power management and touch screen controller 1720 manages power used by the processing circuit 1726 and touch control. The communication bus 1722, which may be an Industry Standard Architecture (ISA), Extended Industry Standard Architecture (EISA), Video Electronics Standards Association (VESA), Peripheral Component Interface (PCI), or similar, for interconnecting all of the components of the processing circuit 1726. A description of the general features and functionality of the display 1710, buttons 1714, as well as the display controller 1708, power management controller 1720, network controller 1706, and I/O interface 1712 is omitted herein for brevity as these features are known.

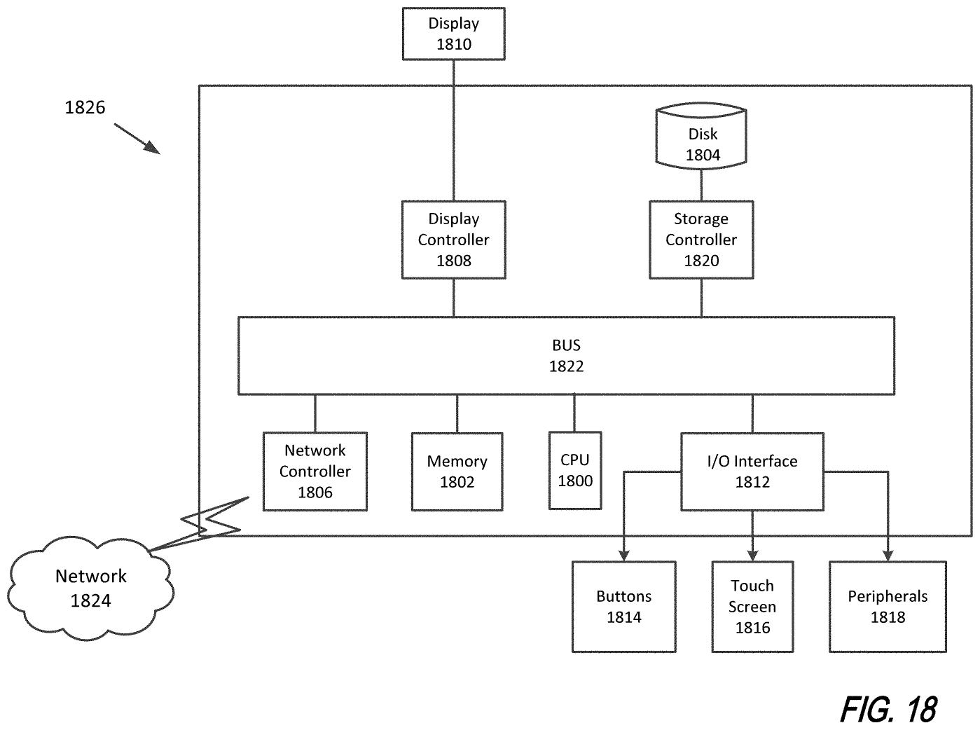

As an alternative, or in addition to the mobile device, any computer having a graphical display device may be used, for example, for setting up accounts and registering vehicles. In addition, the a computer associated with a parking facility may be a server running any known server operating system. FIG. 18 is a block diagram of a computer system in accordance with an exemplary aspect of the disclosure.

In one implementation, the functions and processes of a computer system having a Web interface may be implemented by a computer 1826. Next, a hardware description of the computer 1826 according to exemplary embodiments is described with reference to FIG. 18. In FIG. 18, the computer 1826 includes a CPU 1800 which performs the processes described herein. The process data and instructions may be stored in memory 1802. These processes and instructions may also be stored on a storage medium disk 1804 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer 1826 communicates, such as a server or computer.

Further, the claimed advancements may be provided as a utility application, background daemon, or component of an operating system, or combination thereof, executing in conjunction with CPU 1800 and an operating system such as Microsoft® Windows®, UNIX®, Oracle® Solaris, LINUX®, Apple macOS® and other systems known to those skilled in the art.

In order to achieve the computer 1826, the hardware elements may be realized by various circuitry elements, known to those skilled in the art. For example, CPU 1800 may be a Xenon® or Core® processor from Intel Corporation of America or an Opteron® processor from AMD of America, or may be other processor types that would be recognized by one of ordinary skill in the art. Alternatively, the CPU 1800 may be implemented on an FPGA, ASIC, PLD or using discrete logic circuits, as one of ordinary skill in the art would recognize. Further, CPU 1800 may be implemented as multiple processors cooperatively working in parallel to perform the instructions of the inventive processes described above.

The computer 1826 in FIG. 18 also includes a network controller 1806, such as an Intel Ethernet PRO network interface card from Intel Corporation of America, for interfacing with network 1824. As can be appreciated, the network 1824 can be a public network, such as the Internet, or a private network such as LAN or WAN network, or any combination thereof and can also include PSTN or ISDN sub-networks. The network 1824 can also be wired, such as an Ethernet network, or can be wireless such as a cellular network including EDGE, 3G and 4G wireless cellular systems. The wireless network can also be WiFi®, Bluetooth®, or any other wireless form of communication that is known.

The computer 1826 further includes a display controller 1808, such as a NVIDIA® GeForce® GTX or Quadro® graphics adaptor from NVIDIA Corporation of America for interfacing with display 1810, such as a Hewlett Packard® HPL2445w LCD monitor. A general purpose I/O interface 1812 interfaces with a keyboard and/or mouse 1814 as well as an optional touch screen panel 1816 on or separate from display 1810. General purpose I/O interface also connects to a variety of peripherals 1818 including printers and scanners, such as an OfficeJet® or DeskJet® from Hewlett Packard®.

The general purpose storage controller 1820 connects the storage medium disk 1804 with communication bus 1822, which may be an ISA, EISA, VESA, PCI, or similar, for interconnecting all of the components of the computer 1826. A description of the general features and functionality of the display 1810, keyboard and/or mouse 1814, as well as the display controller 1808, storage controller 1820, network controller 1806, and general purpose I/O interface 1812 is omitted herein for brevity as these features are known.

Numerous modifications and variations of the present invention are possible in light of the above teachings. It is therefore to be understood that within the scope of the appended claims, the invention may be practiced otherwise than as specifically described herein.

1. A vehicle parking notification system, comprising:
an in-vehicle electronic device including
a first wireless communication controller circuitry,
a memory storing an id of a vehicle,
at least one antenna,
the first wireless communication controller circuitry configured to:
respond to a request for the vehicle id, via the at least one antenna,
retrieve position information of the vehicle when the request for the vehicle id is made, the position information indicating that the vehicle is located at a parking facility, and
record in the memory a time that the request for vehicle id is made and the position information; and
an external computer, remote from the vehicle, including processing circuitry,
a second wireless communication controller circuitry, and
a display device,
the processing circuitry configured to:
receive, via the second wireless communication controller circuitry, an expiration time that parking at the parking facility expires determined based on the time associated with the request for vehicle id, and
display, via the display device, at a predetermined time period before the expiration time a notification message indicating the predetermined time period before the expiration time.

2. The vehicle parking notification system of claim 1, wherein the received expiration time includes a parking facility closing time and a paid parking expiration time,
wherein the processing circuitry is further configured to display, via the display device, at a predetermined time period before the expiration time a first notification message indicating the at least one predetermined time period before the parking facility closing time or a second notification message indicating the at least one predetermined time period before the paid parking expiration time, whichever comes first.

3. The vehicle parking notification system of claim 1, wherein the in-vehicle electronic device further includes a transceiver configured for communication within the vehicle,
wherein the first wireless communication controller circuitry receives the position information of the vehicle in a parking facility by way of the transceiver.

4. The vehicle parking notification system of claim 1, further comprising a satellite communication device configured to receive the position information of the vehicle and calculate position coordinates that are within the parking facility.

5. The vehicle parking notification system of claim 1, further comprising a centralized database storing vehicle information including vehicle make, model, and color, for vehicles of registered users,
wherein the first wireless communication controller circuitry is configured to automatically respond to the request for the vehicle id from a communication device of a parking facility, via the at least one antenna, and
wherein the database is accessed by the communication device of the parking facility to retrieve the vehicle information for the vehicle id.

6. The vehicle parking notification system of claim 1, wherein the first wireless communication controller circuitry is further configured to:
respond to a second request for the vehicle id, via the at least one antenna,
retrieve second position information of the vehicle when the second request for the vehicle id is made, the second position information indicating that the vehicle is exiting the parking facility.

7. The vehicle parking notification system of claim 1, wherein the processing circuitry is further configured to:
receive, via the second wireless communication controller circuitry, the expiration time that parking at the parking facility expires determined based on the time associated with the request for vehicle id, and
display, via the display device, at a predetermined time period before the expiration time the notification message including an input form configured to input an increase in the expiration time to a later time.

8. The vehicle parking notification system of claim 1, wherein the processing circuitry is further configured to:
receive, via the second wireless communication controller circuitry, the expiration time that parking at the parking facility expires determined based on the time associated with the request for vehicle id, and
display, via the display device, at the predetermined time period before the expiration time the notification message indicating that the vehicle will be towed if not moved by the expiration time.

9. The vehicle parking notification system of claim 1, further comprising a plurality of electronic devices within a plurality of respective vehicles, each vehicle including an electronic device,
wherein the processing circuitry is further configured to
receive, via the second wireless communication controller circuitry, an expiration time that parking for least one parking facility expires determined based on the time associated with the request for vehicle id for at least one of the plurality of vehicles, and
display, via the display device, at a predetermined time period before the expiration time a notification message indicating the predetermined time period before the expiration time of a respective parking facility.

10. The vehicle parking notification system of claim 1, wherein one antenna of the at least one antenna is a radio frequency antenna,
wherein the first wireless communication controller circuitry is configured to:
respond to the request for the vehicle id, via the radio frequency antenna,
wherein the second wireless communication controller circuitry performs communication by cellular communications,
wherein the processing circuitry is configured to receive, via the cellular communications, an expiration time that parking at the parking facility expires determined based on the time associated with the request for vehicle id.

11. A non-transitory computer-readable storage medium storing program instructions which when executed perform a method comprising:
wirelessly responding, by an in-vehicle wireless communication controller circuitry, to a request for an id of a vehicle;
retrieving, by the in-vehicle wireless communication controller circuitry, position information of the vehicle when the request for the vehicle id is made, the position information indicating that the vehicle is located at a parking facility;
recording in a memory, connected to the in-vehicle wireless communication controller circuitry, a time that the request for vehicle id is made and the position information;
receiving, via a second wireless communication controller circuitry of an external remote computer, an expiration time that parking at the parking facility expires determined based on the time associated with the request for vehicle id; and
displaying, via a display device of the external remote computer, at a predetermined time period before the expiration time a notification message indicating the predetermined time period before the expiration time.

12. The non-transitory computer-readable storage medium of claim 11, wherein the received expiration time includes a parking facility closing time and a paid parking expiration time,
wherein the execution of the instructions further includes displaying, via the display device, at a predetermined time period before the expiration time, a first notification message indicating the at least one predetermined time period before the parking facility closing time or a second notification message indicating the at least one predetermined time period before the paid parking expiration time, whichever comes first.

13. The non-transitory computer-readable storage medium of claim 11, further including a transceiver configured for communication within the vehicle,
wherein the execution of the instructions further includes receiving the position information of the vehicle in a parking facility by way of the transceiver.

14. The non-transitory computer-readable storage medium of claim 11, further including a satellite communication device configured to receive the position information of the vehicle,
wherein the execution of the instructions further includes calculating position coordinates that are within the parking facility.

15. The non-transitory computer-readable storage medium of claim 11, further comprising a centralized database storing vehicle information including vehicle make, model, and color, for vehicles of registered users,
wherein the execution of the instructions further includes
automatically responding to the request for the vehicle id from a communication device of a parking facility; and
accessing the database by the communication device of the parking facility to retrieve the vehicle information for the vehicle id.

16. The non-transitory computer-readable storage medium of claim 11, wherein the execution of the instructions further includes
responding to a second request for the vehicle id; and
retrieving second position information of the vehicle when the second request for the vehicle id is made, the second position information indicating that the vehicle is exiting the parking facility.

17. The non-transitory computer-readable storage medium of claim 11, wherein the execution of the instructions further includes
receiving, via the second wireless communication controller circuitry, the expiration time that parking at the parking facility expires determined based on the time associated with the request for vehicle id; and
displaying, via the display device, at the predetermined time period before the expiration time the notification message including an input form configured to input an increase in the expiration time to a later time.

18. The non-transitory computer-readable storage medium of claim 11, wherein the execution of the instructions further includes
receiving, via the second wireless communication controller circuitry, the expiration time that parking at the parking facility expires determined based on the time associated with the request for vehicle id; and
displaying, via the display device, at the predetermined time period before the expiration time the notification message indicating that the vehicle will be towed if not moved by the expiration time.

19. The non-transitory computer-readable storage medium of claim 11, further comprising a plurality of electronic devices within respective plurality of vehicles,
wherein the execution of the instructions further includes
receiving, via the second wireless communication controller circuitry, an expiration time that parking for least one parking facility expires determined based on the time associated with the request for vehicle id for at least one of the plurality of vehicles; and
receiving and displaying, via the display device, at a predetermined time period before the expiration time a notification message indicating the predetermined time period before the expiration time of a respective parking facility.

20. The non-transitory computer-readable storage medium of claim 11, wherein the execution of the instructions further includes,
responding to the request for the vehicle id, via a radio frequency antenna connected to the in-vehicle wireless communication controller circuitry; and
receiving, via cellular communications performed by the second wireless communication controller, an expiration time that parking at the parking facility expires determined based on the time associated with the request for vehicle id.
